(19) United States
(12) Patent Application Publication
(10) Pub. No.: US 2008/0023963 A1
(43) Pub. Date: Jan. 31, 2008

(54) HYDROELECTRIC POWER AND DESALINATION

(76) Inventor: Stephen Perich, Houston, TX (US)

Correspondence Address: EDMONDS, P.C., 16815 ROYAL CREST DRIVE, SUITE 130, HOUSTON, TX, 77058, US

(21) Appl. No.: 11/780,980

(22) Filed: Jul. 20, 2007

Related U.S. Application Data
(60) Provisional application No. 60/833,399, filed on Jul. 26, 2006.

(51) Int. Cl. E02B 9/00; C02F 1/04; F01D 15/10

(52) U.S. Cl. 290/52; 202/185.1; 203/10; 405/75; 60/398

(57) ABSTRACT

Methods and systems for producing electrical power, desalinated water, and/or salt are provided. The system can include one or more first turbines in fluid communication with a body of salt water; one or more boilers for heating the salt water to provide steam and brine; and one or more second turbines in fluid communication with the steam for producing the electrical power.

### REFERENCE TO RELATED APPLICATIONS

This application claims benefit of US Provisional Patent Application having Ser. No. 60/833,399, filed on Jul. 26, 2006, which is incorporated by reference herein.

### BACKGROUND OF THE INVENTION

1. Field of the Invention

Embodiments of the present invention generally relate to systems and methods for producing hydroelectric power. More particularly, embodiments of the present invention relate to systems and methods for producing hydroelectric power, desalinated water, and/or salt from a body of salt water.

2. Description of the Related Art

The conventional production of hydroelectric power, desalinated water and salt raise both environmental and economic concerns. Such production facilities are typically located near or along a body of water which can have a detrimental effect of the surrounding habitats, wildlife and environment. Such detrimental effects can be noticed immediately and can accumulate over time.

Hydroelectric power, for example, comes from transforming potential energy of dammed water into shaft power and then to electricity using a hydraulic turbine direct-coupled to an electric generator. The power produced using a hydraulic turbine can be dependent on the volume of water drawn through the hydraulic turbine and the difference in elevation between the water source and the centerline of the hydraulic turbine.

Traditional hydroelectric power generation relies on an elevated reservoir, typically by damming river water or other fresh water reservoir. Water can then be drawn from the river and directed through a large bore piping network, referred to as a penstock, to a hydraulic turbine direct-coupled to an electric generator. Water is exhausted from the turbine and returned to the river at the base of the dam.

A tremendous quantity of water is required to provide continuous power. As such, vast hydroelectric reservoirs are required to assure a continuous flow of water to, and thus a continuous flow of power from, the hydroelectric facility. For example, the Grand Coulee Dam on the Columbia River in Washington State flows approximately 10,000 cubic feet of water per second across a 380 foot change in elevation, giving it a nameplate generating capacity of approximately 6800 MW of power. In China, the Three Gorges dam project, upon completion in 2009, is projected to have a 7,660 foot long dam standing nearly 620 feet high, that will flow approximately 350,000 cubic feet of water per second across a 360 foot change in elevation and will have a nameplate capacity of approximately 22,500 MW at peak production. The Three Gorges reservoir will extend approximately 410 miles upstream of the dam and will cover approximately 244 square miles, which can severely disrupt aquatic life both upstream and downstream of the dam.

Such conventional hydroelectric generation designs raise both environmental and economic concerns, including river damage and water shortages to nearby land and communities. Moreover, the silting due to the reduction of flow to native estuaries that often accompanies the installation of a dam, makes navigation difficult and often requires extensive and disruptive dredging operations to maintain navigability.

Global water demand for human consumption and/or agricultural purposes is also increasing, especially in places where access to fresh water is limited. Desalination facilities have been used to convert an available salt water supply to fresh water. Most desalination facilities currently in use throughout the world employ reverse osmosis techniques to remove salt and other impurities from salt water. The two largest desalination facilities in the world are in Tampa Bay (25 million gallons/day) and Carboneras-Almeria, Spain (32 million gallons/day). Such facilities are costly and typically consume a large foot print on land near the source of salt water, i.e along or near a coastline. The location of such large scale industrial facilities in close proximity to the coastline consumes valuable real estate and threatens environmentally sensitive areas.

Furthermore, a large share of the world's salt is made in close proximity to a coastline to ensure access to a steady supply of salt water or brine. Salt is typically made by the ancient methods of trapping seawater or brine springs, evaporating the brine and concentrating the salt, using either a solar or manmade heat source. For example, Cargill operates a 650,000 ton/year salt production facility using evaporation and is located along the central California coast in Newark, Calif. Altogether, in the San Francisco bay area alone, in excess of 16,000 acres have been, at one time or another, dedicated to salt ponds.

There is a need, therefore, for an improved system and method for the generation of hydroelectric power and for the production of fresh water and salt in a manner that minimizes the detrimental impact on the surrounding area and environment.

### SUMMARY OF THE INVENTION

Methods and systems for producing hydroelectric power, desalinated water, and/or salt are provided. In at least one specific embodiment, the system can include one or more first turbines in fluid communication with a body of salt water; one or more boilers for heating the salt water to provide steam and brine; and one or more second turbines in fluid comnunication with the steam for producing electrical power.

In at least one specific embodiment, the method can include flowing salt water through one or more first turbines to provide electrical power; heating the salt water using one or more boilers to provide steam and brine; and producing electrical power using one or more second turbines in fluid communication with the steam.

In at least one other specific embodiment, salt water can flow through one or more fluid conduits to a subterranean chamber having one or more electrical generators and brine evaporation systems disposed therein. At least a portion of the salt water can be directed through one or more hydraulic turbines to provide electrical power, and at least a portion of the salt water can be directed to one or more steam generators to provide steam and a concentrated brine solution. At least a portion of the steam can be directed through one or more turbines to provide electrical power and a lower pressure steam, and at least a portion of the concentrated brine solution can be directed to the one or more brine evaporation systems to provide salt. At least a portion of the lower pressure steam can be condensed or at least partially condensed to provide desalinated water.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block flow diagram of an illustrative process for producing hydroelectric power, desalinated water and/or salt, according to one or more embodiments described.

FIG. 2 depicts a block flow diagram of another illustrative process for producing hydroelectric power, desalinated water and/or salt, according to one or more embodiments described.

FIG. 3 depicts an illustrative system for a combined hydroelectric facility capable of producing hydroelectric power, desalinated water and/or salt, according to one or more embodiments described.

### DETAILED DESCRIPTION

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions, when the information in this patent is combined with available information and technology.

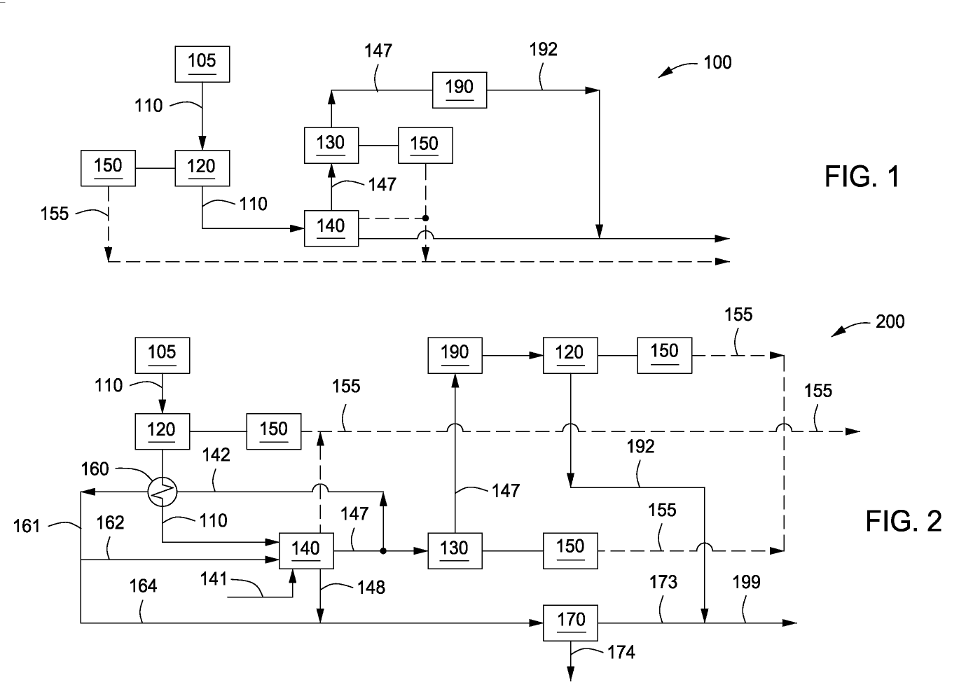

FIG. 1 depicts a block flow diagram of an illustrative process 100 for producing hydroelectric power, desalinated water and/or salt, according to one or more embodiments described. In one or more embodiments, water from one or more bodies of water 105 flows underground via line 110 through one or more turbines 120 (‘first turbines’ or “hydraulic turbines”) closely coupled or direct-coupled to one or more generators 150 (“first generators”), producing electrical power via line 155. The body of water 105 can be a sea or ocean containing a vast quantity of water, preferably salt water. However, any reservoir or plurality of reservoirs (i.e. two or more), natural or man-made, can be used such as a lake, pond, river, sea, and/or ocean. The term “salt water” as used herein refers to water having a salt content of 0.5 wt % or more, including 1.0 wt % or more, 2.0 wt % or more, 3.0 wt % or more, 4.0 wt % or more, or 5.0 wt % or more. The term “salt” can include sodium, potassium, calcium and any other Groups I-IV metals, either alone or in any combination.

The water from the body 105 can continue to flow below sea level to the one or more boiler rooms 140. In one or more embodiments, the boiler room 140 can be located below sea level and can be inside an enclosure made of concrete or steel or other suitable material(s) within a man-made facility or a naturally occurring cavern. The boiler room 140 can include one or more boilers or furnaces disposed therein for heating the fallen water to a temperature sufficient to evaporate or boil the salt water, producing steam via line 147. The boilers or furnaces can be heated using gas, coal, waste heat from a combined cycle process, waste process heat, inductive or resistive electrical heaters or any combination thereof. Although not shown, the boiler room 140, in one or more embodiments above or elsewhere herein, can include one or more electrical resistive heaters gas fired heaters and/or coal fired heaters, which be used continuously, intermittently or in a swing type arrangement, depending on process requirements.

The steam generated within the boiler room 140 can be used to turn or drive one or more steam turbines 130 (“second turbines” or “steam turbines”) disposed in fluid communication with line 147. The one or more steam turbines 130 can be direct-coupled to one or more generators 150 (“second generators”) for producing electrical power which can be added to line 155 or returned to the boiler room 140 for to provide all or pan of the required heat and/or power to operate the furnaces or boilers therein. Although not shown, the turbines 120, 130 can be coupled or used to drive the same (i.e. tandem) one or more generators 150.

In one or more embodiments, at least a portion of the electrical power 155 produced from the process 100, i.e. power from the one or more generators 150 in communication with either the hydraulic turbine(s) 120 or the steam turbine(s) 130 or both, can be directed to the boiler room 140 to power the one or more boilers or furnaces therein. In one or more embodiments, at least a portion of the electrical power 155 can be used to power auxiliary equipment or sold for commercial use via a local grid (not shown).

From the turbine(s) 130, the steam can rise toward sea level and can be condensed in situ or within one or more condensation units 190. The one or more condensation units 190 can condense or otherwise transfer the vaporized steam to a liquid phase or substantially liquid phase to provide desalinated water via line 192. The optional one or more condensation units 190 can be located above or below ground. In one or more embodiments, the one or more condensation units 190 can be located in proximity to the boiler room 140 or in proximity to the body of water 105 or in proximity to a nearby water treatment facility (not shown). The one or more condensation units 190 can include one or more quench towers, air coolers, or other conventional heat exchangers such as shell and tube types, plate and frame, etc. Any heat transfer medium, including air, water or refrigerant, can be used to remove heat from the steam to provide liquid phase water. In one or more embodiments, water from the body of water 105 can be used to cool the steam. Although not shown, the falling water in line 110 can be in direct or indirect heat exchange with line 147 to condense the steam to a liquid phase.

FIG. 2 depicts a block flow diagram of another illustrative process 200 for producing hydroelectric power, desalinated water and/or salt, according to one or more embodiments described. As shown in FIG. 2, the process 200 can further include one or more hydraulic turbines 120 (“third turbines”) and generators 150 (“third generators”) located downstream of the one or more condensation units 190. Such coupled turbine and generator can take advantage of potential energy from an elevated location of the condensation units 190 relative to the combined water line 199. Further, the third generator(s) can provide additional power to the power line 155, depending on process and power requirements.

In one or more embodiments, the process 200 can include a recycle or bypass line 142 containing steam from the boiler room 140. For example, at least a portion of line 147 can be directed to one or more heat exchangers 160 via line 142. Line 142 can be used to preheat the falling water via line 110. Each heat exchanger 160 can be located at the surface or below sea level. Each heat exchanger 160 can also be located within the enclosure of the boiler room 140, if desired. The steam via line 142 can be condensed or partially condensed upon heat exchange with line 110. The condensate, whether single or dual phase condensate, via line 161 can be recycled or otherwise directed via line 162 to the boiler room 140 for evaporation and additional heat. In one or more embodiments, the condensate, whether single or dual phase, can be directed to the brine treatment unit 170 via line 164.

In one or more embodiments, a fuel source or supplemental fuel source, such as natural gas, coal, and/or another fuel source can be supplied to the boiler room 140 via line 141. Line 141 can be used to regulate or control the amount of heat produced by the boilers/furnace(s) therein. In the event the amount of power produced from the one or more generators 150 is not sufficient to provide the energy duty to evaporate a sufficient amount of water, line 141 can be used to provide additional energy or an alternative source of energy. As mentioned above, the boiler room 140 can include one or more electrical resistive heaters, one or more gas fired heaters, and/or one or more coal fired heaters operating continuously, intermittently or in a swing type arrangement, depending on process requirements.

In one or more embodiments, salt and non-evaporated water (i.e. brine) that remains after evaporating the fallen water within the boiler room 140 can be collected and sent to one or more brine treatment units 170 via line 148. Line 148 can be combined with line 164 as shown in FIG. 2; alternatively, lines 148 and 164 can be separate feeds to the brine unit 170 (not shown). As used herein, the term “brine” refers to an aqueous solution having at least 5.0 wt % salt by weight.

Each brine treatment unit 170 can include one or more heaters and/or furnaces suitable for evaporating brine, to recover any remaining water via line 173. In at least one specific embodiment, the brine treatment unit 170 can include one or more evaporation basins equipped with resistive or gas-fired heaters. The converted salt from the brine treatment unit 170 can be drained and left underground, represented by line 174. In one or more embodiments, the converted salt from brine treatment unit 170 can be stored or sent to the surface (not shown) for further treatment.

The recovered water via lines 192 and 173 can be combined to form line 199 as shown or left as separate lines. Although not shown, any of the lines 192, 173 and 199 can be returned to the body of water 105. Also, any of the lines 192, 173 and 199 can be further treated for human consumption. Furthermore, any of the lines 192, 173 and 199 can be used for utility water or further treated for consumption or other commercial use. Any of the lines 192, 173 and 199 can also provide the heat transfer medium (i.e. water) to cool the steam via line 147 after exiting the one or more turbines 130 (not shown) or pre-heat the falling water via line 110 (not shown).

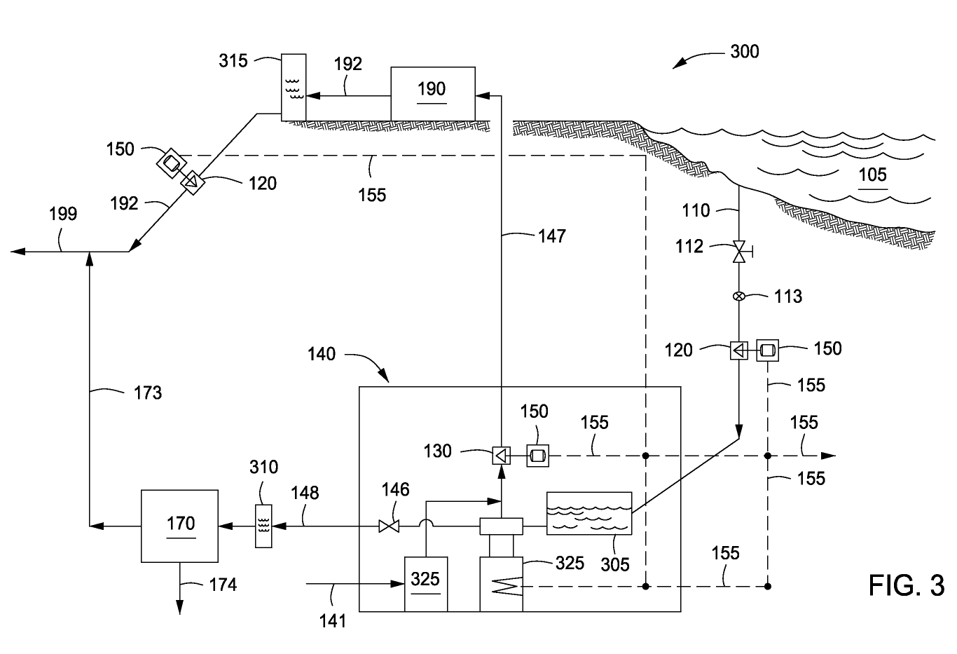

FIG. 3 depicts an illustrative system 300 for a combined hydroelectric facility capable of producing hydroelectric power, desalinated water and/or salt, according to one or more embodiments described. In one or more embodiments, the system 300 can include the one or more hydraulic turbines 120, steam turbines 130, boiler rooms 140, generators 150, brine treatment units 170, and condensation units 190 as described above with reference to FIGS. 1 and 2. In one or more embodiments, the system 300 can further include one or more salt water reservoirs 305, brine reservoirs 310, and/or desalinated water reservoirs 315 to enhance or optimize process controls within the system 300.

The one or more salt water reservoirs 305, if needed, can be disposed within or proximate the boiler room(s) 140. Each salt water reservoir 305 can be in fluid communication with the heater(s) and/or boiler(s) 325 within the boiler room 140 via one or more drain valves 146 disposed in line 148. The salt water reservoir 305 is preferably disposed subsurface and can be any type of storage tank or cavern formed in the earth. In one or more embodiments, the one or more salt water reservoir 305 are located within the enclosure of the boiler room 140.

As described above, the falling water from the body of water 105 can flow through the one or more turbines 120 to the one or more boiler rooms 140. The one or more salt water reservoirs 305 can be used to collect the falling water and provide storage or an inventory of water for better process control.

The one or more brine reservoirs 310, if needed, can be disposed within or proximate to the brine treatment unit(s) 170. Each brine reservoir 310 can be in fluid communication with the boiler room(s) 140 via one or more drain valves 146 disposed in line 148. The brine reservoir 310 is preferably disposed subsurface and can be any type of storage tank or cavern formed in the earth. In one or more embodiments, the one or more brine reservoirs 310 are located within the enclosure of the boiler room 140.

The one or more desalinated water reservoirs 315, if needed, can be in fluid communication with the condensation units 190. The desalinated water reservoirs 315 can be located subsurface or at the surface as depicted in FIG. 3. Each water reservoir 315 can be any type of storage tank used to store potable water. In one or more embodiments, the reservoirs 315 can be vertical, horizontal, cylindrical, or spherical. In one or more embodiments, the reservoirs 315 can include a domed roof or a floating roof.

Considering line 110 in more detail, line 110 can be one or more conduits or tubulars, including a penstock, or simply a bore hole formed in the earth. Referring to FIGS. 1-3, line 110 can be cemented in place or left in an open hole arrangement as is common for penstocks and tubulars in the oil and gas industry. In one or more embodiments, an interior of the line 110 can be coated with a biocide or other suitable material, such as copper or copper impregnated coatings, for inhibiting marine life growth, such as barnacles.

Each line 110 can be located at any depth related to the surface of the body of water 105. In one or more embodiments, one or more lines 110 can originate at a multitude of different levels or depths relative to the surface of the body of water 105 to accommodate variations in water level over a period of time, such as during low tide or a dry season, for example. In one or more embodiments above or elsewhere herein, each line 10 can include one or more valves or other components to regulate and/or control water flow therethrough. A gate valve 112 and gate 113 are shown for illustration.

In operation, the valve 112 can be opened to allow salt water to fall into line 110. The salt water can pass through turbines 120 (“first turbines”) that are connected to the one or more generators 150 (“first generators”), which can produce electricity. The water can continue to fall via line 110 to the boiler room 140. In the boiler room 140, the salt water can be heated by the one or more furnaces/boilers 325 to produce steam via line 147. The steam in line 147 can be low pressure steam, medium pressure steam or high pressure steam, depending on the heat input and system requirements. As mentioned, any one or more boilers 325 can be powered by natural gas, coal, electrical energy generated from the generators 150, or a combination of these energy and/or other sources. The steam via 147 can flow through the one or more steam turbines 130 (“second turbines”) that are connected to the generators 150 (“second generators”) which can create electricity when the turbines are turned by the steam.

The steam leaving the steam turbines 130 can enter the condensation unit 190. In the condensation unit 190, the steam can condense or at least partially condense into water. Line 192 containing the condensed steam (i.e. water) can convey the water from the condensation unit 190 to the reservoir(s) 315. At least a portion of the water can be released from the reservoirs 315 into a distribution system (not shown). In one or more embodiments, at least a portion of the water can be released from the reservoirs 315 to the one or more turbines 120 (“third turbines”) disposed within line 192. The turbine(s) 120 can be connected to the generators 150 (“third generators”) to create electricity which can be added to line 155. The electricity generated in any of the generators 150 can be used to power the boilers 325 or can be used for commercial use.

The remaining salt water not converted to steam by the boilers 325 can be converted into brine via line 148. Line 148 can exit the boiler room 140 by passing through the drain valve 146 into the brine tank 310. The separated or otherwise recovered salt from the brine treatment unit 170 can be transported from the system 300 using an elevator shaft line 73 and can be used for sold or commercial use.

Referring to FIGS. 1-3, line 110 can have a temperature ranging from a low of about −2° C., 0° C., or 2° C. to a high of about 50° C., 70° C., or 100° C. In one or more embodiments, line 110 can have a temperature ranging from about 5° C. to about 25° C. The pressure of the line 110 can range from a low of about 100 kPa, 125 kPa, or 150 kPa to a high of about 600 kPa, 800 kPa, or 1,000 kPa. In one or more embodiments, line 110 can have a pressure ranging from about 175 kPa to about 500 kPa. The salinity of line 110 can range from a low of about 0.5%, 1%, or 1.5% to a high of about 4%, 4.5%, or 5%. In one or more embodiments, line 110 can have a salinity ranging from about 2% to about 3.5%. The length of line 110 can be 10 feet or more. In one or more embodiment, the length of line 110 can be 50 feet or more, 500 feet or more, or 5000 feet or more.

Line 147 can have a temperature ranging from a low of about 150° C., 225° C., or 300° C. to a high of about 500° C., 550° C., or 600° C. In one or more embodiments, line 147 can have a temperature ranging from about 400° C. to about 450° C. The pressure of line 147 can range from a low of about 2,000 kPa, 3,000 kPa, or 4,000 kPa to a high of about 7,000 kPa, 8,000 kPa, or 9,000 kPa. In one or more embodiments, line 147 can have a pressure ranging from about 5,000 kPa to about 6,000 kPa.

Line 192 can have a temperature ranging from a low of about 5° C., 10° C., or 15° C. to a high of about 60° C., 70° C., or 80° C. In one or more embodiments, line 192 can have a temperature ranging from about 20° C. to about 50° C. The pressure of line 192 can range from a low of about 100 kPa, 105 kPa, or 110 kPa to a high of about 125 kPa, 130 kPa, or 135 kPa. In one or more embodiments, line 192 can have a pressure ranging from about 115 kPa to about 120 kPa.

Line 148 can have a temperature ranging from a low of about 65° C., 70° C., or 75° C. to a high of about 90° C., 95° C., or 100° C. In one or more embodiments, line 148 can have a temperature ranging from about 80° C. to about 85° C. The pressure of line 148 can range from a low of about 100 kPa, 110 kPa, or 120 kPa to a high of about 140 kPa, 150 kPa; or 160 kPa. In one or more embodiments, line 148 can have a pressure ranging from about 125 kPa to about 135 kPa. The salinity of line 148 can range from a low of about 5%, 10%, or 12% to a high of about 20%, 22%, 25%. In one or more embodiments, line 148 can have a salinity ranging from about 15% to about 18%.

Embodiments described can provide hydroelectric power from an alternative water source with the added benefit of producing desalinated water and/or salt, in addition to electrical power. The synergistic combination of electric production using readily available conventional hydroelectric, coal and/or gas technologies, with desalination and/or salt production into a single, integrated, facility can provide commodities essential to the development of remote locations.

Moreover, the ability to provide power and fresh water with minimal environmental impact can support agricultural development such as tree farms and/or other forms of carbon sinks in areas previously unsuitable due to a lack of fresh water or governmental land-use regulations. The use of one or more hydraulic turbines permits the generation of electrical power within the combined facility, improving the energy efficiency of the facility over similarly sized surface facilities, while at the same time providing desalinated water and salt as fungible products. Embodiments described can also support the development of a surface “green space” providing potentially marketable carbon offsets. Furthermore, embodiments described provide an efficient and environmentally friendly process and system for producing the world's most basic commodities: water, salt, and power.

The foregoing discussion can be further described with reference to the following non-limiting, prophetic example.

### PROPHETIC EXAMPLE

A steam boiler installation is located 100 feet beneath a body of saline water with approximately 3.5% salt concentration. The water is drafted at a rate of 10 ft³/sec through a first hydraulic turbine and into a boiler feed drum. Using one or more boilers, the salt concentration is increased to 17.5% by evaporating 8 ft³/sec of water to produce 600 psig (4136 kPa), 600° F. (316° C.) superheated steam and 2 ft³/sec of 17.5% brine. The 600 psig, 600° F. superheated steam is expanded to 15 psig, 250° F. saturated steam using a conventional non-condensing or reheat steam turbine to provide electrical power to the facility and for export to the regional electric grid. The 15 psig steam can be distributed to local industrial consumers or can be condensed to provide 8 ft³/sec of condensate which can be directed through a second hydraulic turbine into a storage tank for disposal or distribution via one or more municipal and/or agricultural water systems. The predicted incremental energy production increase for this facility over a conventional power plant is summarized in Table 1.

TABLE 1
Facility Incremental Energy Production Summary

| Stage | Power Generated (kW) |
|---|---|
| First Hydraulic Turbine* | 64 |
| Second Hydraulic Turbine* | 21 |
| Total Facility | 85 |

*based on 75% conversion efficiency

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or approximately” the indicated value, and take into account experimental error and variations that would be expected by a person having ordinary skill in the art. Unless otherwise noted, all saline percentages are reported by weight salt.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

What is claimed is:

1. A system for producing hydroelectric power and desalinated water, comprising:
one or more first turbines in fluid communication with a body of salt water;
one or more boilers for heating the salt water to provide steam and brine; and
one or more second turbines in fluid communication with the steam for producing electrical power.

2. The system of claim 1, further comprising one or more condensation units to condense the steam into desalinated water.

3. The system of claim 2, further comprising one or more reservoirs for receiving and storing the desalinated water.

4. The system of claim 3, further comprising one or more third turbines in fluid communication with the one or more reservoirs.

5. The system of claim 1, wherein energy from the one or more first turbines is communicated to one or more generators for producing electrical power.

6. The system of claim 4, wherein energy from the one or more third turbines is communicated to one or more generators for producing electrical power.

7. The system of claim 5, wherein the desalinated water flows through the one or more third turbines at a rate sufficient to generate power for commercial use.

8. The system of claim 1, wherein the one or more first turbines are in fluid communication with the body of salt water via one or more conduits adapted to flow the salt water therethrough.

9. The system of claim 8, wherein the one or more conduits include one or more gate valves disposed therein for controlling the flow of salt water through the one or more first turbines and into the one or more boilers.

10. The system of claim 1 wherein the one or more boilers are gas fired boilers.

11. The system of claim 5, wherein the one or more boilers are resistive heaters powered by the one or more generators.

12. The system of claim 6, wherein the one or more boilers are resistive boilers powered by the one or more generators.

13. The system of claim 1, further comprising one or more brine tanks.

14. The system of claim 13, further comprising a drain valve in fluid communication with the one or more brine tanks for receiving a brine solution created by heating and evaporating at least a portion of the salt water.

15. The system of claim 14, further comprising one or more brine treatment units for removing salt from the brine solution.

16. The system of claim 1, wherein the one or more first turbines, the one or more boilers, and the one or more second turbines are disposed underground.

17. A method for producing hydroelectric power and desalinated water, comprising:
flowing salt water through one or more first turbines to provide electrical power;
heating the salt water using one or more boilers to provide steam and brine; and
producing electrical power using one or more second turbines in fluid communication with the steam.

18. The method of claim 17, further comprising powering the one or more boilers with electrical energy provided by the one or more first turbines, natural gas, or both.

19. A method for producing desalinated water and salt, comprising:
flowing salt water through one or more fluid conduits to a subterranean chamber having one or more electrical generators and brine evaporation systems disposed therein;
directing at least a portion of the salt water through one or more hydraulic turbines to provide electrical power;
directing at least a portion of the salt water to one or more steam generators to provide steam and a concentrated brine solution;
directing at least a portion of the steam through one or more turbines to provide electrical power and a lower pressure steam;
directing at least a portion of the concentrated brine solution to the one or more brine evaporation systems to provide salt; and
condensing at least a portion of the lower pressure steam to provide desalinated water.

20. The method of claim 19 wherein the subterranean chamber is a man-made, sub-surface structure disposed at an elevation beneath sea level.
